(19) United States
(12) Patent Application Publication
(10) Pub. No.: US 2014/0090938 A1
(43) Pub. Date: Apr. 3, 2014

(54) TUBE FORMING METHOD AND SHOCK ABSORBER

(71) Applicant: HITACHI AUTOMOTIVE SYSTEMS, LTD., Ibaraki (JP)

(72) Inventor: Makoto NISHIMURA, Tokyo (JP)

(73) Assignee: HITACHI AUTOMOTIVE SYSTEMS, LTD., Ibaraki (JP)

(21) Appl. No.: 14/033,597

(22) Filed: Sep. 23, 2013

(30) Foreign Application Priority Data
Sep. 28, 2012 (JP) 217073/2012

(51) Int. Cl. F16F 9/32; F16F 9/06

(52) U.S. Cl. CPC F16F 9/3235; F16F 9/062
USPC 188/269; 72/206

(57) ABSTRACT

A separator tube 4 is manufactured by a forming method including three steps: a groove forming step of forming a housing 22 by beading; a pressing step of pressing at least one corner of an opening of the housing 22 to form an impression; and a sizing step of sizing an end 20 of the separator tube 4. Thus, the housing 22 can be formed on the inner periphery 21 of the end 20 of the separator tube 4 with high accuracy without performing cutting.

### BACKGROUND OF THE INVENTION

The present invention relates to a tube forming method and a shock absorber.

Among cylinder apparatus incorporated in suspension systems of vehicles, there is known one that has a separator tube between a cylinder and an outer tube. A separator tube disclosed in Japanese Patent Application Publication No. H11-159563, for example, is fitted to the outer periphery of a cylinder through O-rings (seal members) provided on the inner periphery sides of the opposite ends of the separator tube. The O-rings are required to have high sealing performance (e.g. 20 MPa). It is necessary in order to meet the requirement to increase the accuracy of form of housings (O-ring grooves) formed on the inner periphery side of the separator tube. More specifically, the form accuracy of the housings is required to conform to the standard sizes of housings specified by JIS (Japanese Industrial Standards) B2401. In order to conform to the standard sizes, the housings have conventionally been formed by cutting. However, the use of cutting to form the housings causes an increase in the manufacturing cost of the cylinder apparatus.

### SUMMARY OF THE INVENTION

The present invention has been made in view of the above-described circumstances. Accordingly, an object of the present invention is to provide a method of forming a seal ring groove on the inner periphery side of a tube with high accuracy without performing cutting. Another object of the present invention is to provide a shock absorber having the tube formed by the method of the present invention.

To solve the above-described problem, the present invention provides a tube forming method of forming a groove tor a seal ring on the inner periphery side of a tube. The method includes a roller die inserting and outer die fitting step, a groove forming step, a pressing step, and a sizing step. In the roller die inserting and outer die fitting step, a shaft-shaped roller die is inserted into the inner periphery side of the tube, and an outer die is fitted to the outer periphery of the tube. The roller die has a projection corresponding to the groove on the outer periphery thereof. The outer die comprises at least two splittable die parts and has a recess corresponding to the projection on the inner periphery thereof. In the groove forming step, the roller die is rotationally driven to form the groove on the inner peripheral surface of the tube. In the pressing step, at least one corner of the opening of the groove is pressed. In the sizing step, at least one of portions of the tube that extend from the opening of the groove in the axial direction of the tube is sized into a predetermined inner diameter dimension.

In addition, the present invention provides a shock absorber installed between two members movable relative to each other. The shock absorber includes a cylinder having a hydraulic fluid sealed therein, a piston inserted in the cylinder, a piston rod connected to the piston and extending to the outside of the cylinder, an outer tube provided around the outer periphery of the cylinder, a separator tube provided around the outer periphery of the cylinder and having a circular cylindrical side wail forming an annular passage communicating with the interior of the cylinder, a reservoir formed outside the separator tube between the cylinder and the outer tube and having the hydraulic fluid and a gas sealed therein, and a damping force generating mechanism disposed outside the outer tube. The separator tube has a circumferentially extending seal ring groove formed on the inner periphery side thereof. The seal ring groove has an opening with an impression pressed on at least one side thereof in the axial direction of the separator tube. The inner diameter of a portion of the separator tube that extends from the opening of the seal ring groove toward one side of the axial direction is smaller than the inner diameter of a portion of the separator tube that extends from the opening of the seal ring groove toward the other side of the axial direction.

According to the present invention, a seal ring groove can be formed on the inner periphery side of a tube with high accuracy without performing cutting.

### BRIEF DESCRIPTION OF THE DRAWINGS

FIG. 1 is a sectional view, taken along an axial plane, of a damping force control type hydraulic shock absorber.

FIG. 2 is a sectional view, taken along an axial plane, of a separator tube before housings are formed thereon by beading.

FIG. 3 is an enlarged view of an important part in FIG. 4.

FIG. 4 is a sectional view of a beading device in an embodiment of the present invention, taken along an axial plane of the separator tube.

FIG. 5 is a fragmentary sectional view showing burrs generated on corners at both sides of an opening of a housing obtained by beading.

FIG. 6 is a sectional view of a pressing device having the separator tube set therein, taken along an axial plane of the separator tube.

FIG. 7 is a fragmentary sectional view illustrating a pressing step, particularly illustrating the shape of a projection of a roller die.

FIG. 8 is a fragmentary sectional view illustrating the pressing step, particularly showing a positional relationship between the housing and the projection of the roller die.

FIG. 9 is a sectional view of a sizing device having the separator tube set therein, taken along an axial plane of the separator tube.

FIG. 10 is an enlarged view of an important part in FIG. 9.

### DESCRIPTION OF THE EMBODIMENTS

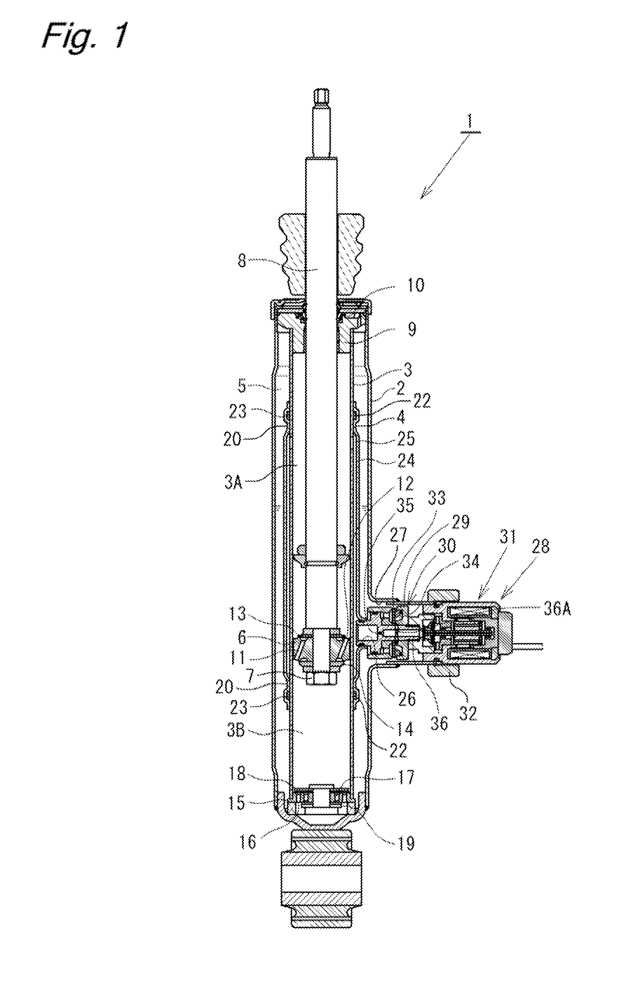

An embodiment of the present invention will be explained below with reference to the accompanying drawings. First, let us explain a damping force control type hydraulic shock absorber 1 of this embodiment. It should be noted that the terms “upper (up)” and “lower (down)” as used in the explanation of the hydraulic shock absorber 1 made with reference to FIG. 1 mean upper (up) and lower (down), respectively, as viewed in FIG. 1. As shown in FIG. 1, the hydraulic shock absorber 1 has a double-tube structure comprising an outer tube 2 and an inner tube 3 (cylinder). Further, the hydraulic shock absorber 1 has a separator tube 4 (tube) disposed between the outer lube 2 and the inner tube 3. A reservoir 5 is formed outside the separator tube 4 between the outer tube 2 and the inner tube 3. The reservoir 5 is an annular space.

A piston 6 is slidably fitted in the inner tube 3. The piston 6 divides the interior of the inner tube 3 into a first chamber 3 A and a second chamber 3B. The piston 6 is secured to one end of a piston rod 8 with a nut 7. The piston rod 8 extends through a rod guide 9 and an oil seal 10, which are provided in the upper end portion of the double-tube structure comprising the outer tube 2 and the inner tube 3. The other end of the piston rod 8 projects to the outside of the inner tube 3. The piston 6 has hydraulic fluid passages 11 and 12 communicating between the first chamber 3A and the second chamber 3B. The piston 6 has a check valve 13 provided on a first chamber 3A-side surface thereof. The check valve 13 allows only a flow of hydraulic oil from the second chamber 3B toward the first chamber 3A through the hydraulic fluid passage 11. Further, the piston 6 has a disk valve 14 provided on a second chamber 3B-side surface thereof. The disk valve 14 opens when the hydraulic oil pressure in the first chamber 3A reaches a predetermined pressure to relieve the hydraulic oil in the first chamber 3A to the second chamber 3B through the hydraulic fluid passage 12.

The hydraulic shock absorber 1 has a base valve 15 provided in the lower end portion of the inner tube 3 to divide the second chamber 38 and the reservoir 5 from each other. The base valve 15 has hydraulic fluid passages 16 and 17 communicating between the second chamber 3B and the reservoir 5. The base valve 15 has a check valve 18 allowing only a flow of hydraulic oil from the reservoir 5 toward the second chamber 38 through the hydraulic fluid passage 16. Further, the base valve 15 has a disk valve 19 that opens when the hydraulic oil pressure in the second chamber 3B reaches a predetermined pressure to relieve the hydraulic oil in the second chamber 3B to the reservoir 5 through the hydraulic fluid passage 17. It should be noted that hydraulic oil is sealed in the inner tube 3 as a hydraulic fluid, and the hydraulic oil and a gas are sealed in the reservoir 5.

As shown in FIG. 1, the separator tube 4 has housings 22 (seal ring grooves) extending circumferentially along the respective inner peripheries 21 of the opposite ends 20 thereof. The housings 22 are fitted with O-rings 23 (seal rings), respectively. The O-rings 23 attached to the ends 20 of the separator tube 4 are brought into close contact with the outer periphery of the inner tube 3, thereby forming an annular hydraulic fluid passage 24 between the inner tube 3 and the separator tube 4. The annular hydraulic fluid passage 24 is communicated with the first chamber 3A through a hydraulic fluid passage 25 provided in the upper end portion of the inner tube 3. The lower end portion of the separator tube 4 is provided with an opening 26 with a small diameter. The outer tube 2 is provided with an opening 27 with a large diameter disposed to correspond to the opening 26. A damping force generating mechanism 28 is attached to the opening 27 of the outer tube 2.

The damping force generating mechanism 28 has a circular cylindrical casing 29 fitted to the opening 27. The casing 29 accommodates a pilot-type (back-pressure type) main damping valve 30 and a solenoid valve 31 serving as a pressure control valve controlling the valve-opening pressure of the main damping valve 30. The main damping valve 30 and the solenoid valve 31 are secured to the casing 29 with a nut 32. The main damping valve 30 and the solenoid valve 31 are connected to the opening 26 to generate damping force by controlling the flow of hydraulic oil from the opening 26 toward the reservoir 5.

The main damping valve 30 has a disk valve 33 and a back-pressure chamber 34 formed at the back of the disk valve 33. The disk valve 33 is a main valve that deflects to open upon receiving the pressure of hydraulic oil on the opening 26 side, thereby allowing the hydraulic oil on the opening 26 side to flow toward the reservoir 5. The back-pressure chamber 34 applies the pressure at the back of the disk valve 33 to the disk valve 33 in the direction for closing the disk valve 33. In addition, a sub-passage 36 is connected to the opening 26 through a fixed orifice 35. The sub-passage 36 is connected to the solenoid valve 31 and communicated with the back-pressure chamber 34 through a passage 36A.

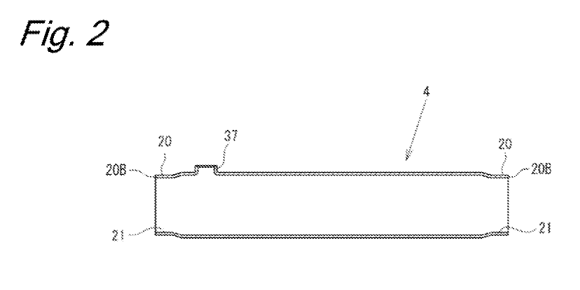

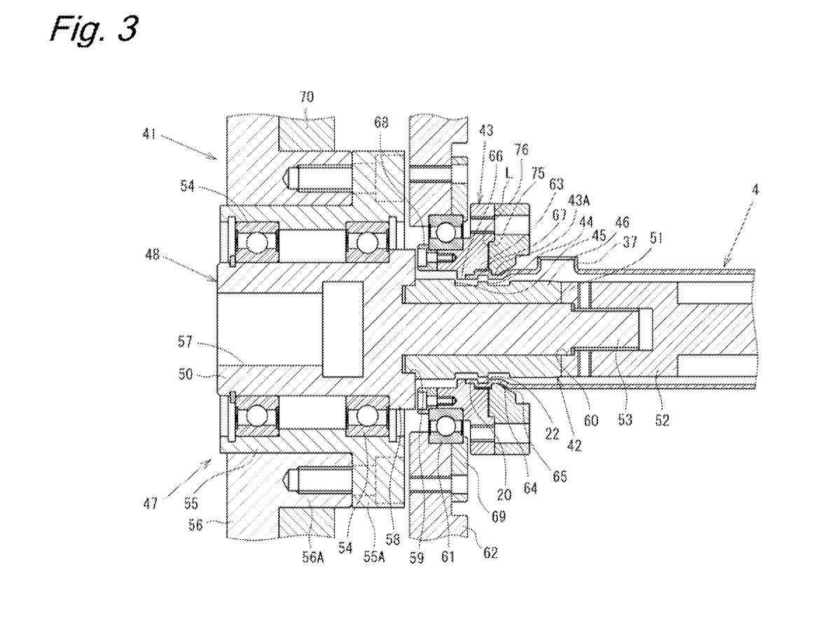

The following is an explanation of a beading device 41 for forming housings 22 (see FIG. 3) on the ends 20 of the separator tube 4 shown in FIG. 2. First, the separator tube 4 before being subjected to beading will be explained. FIG. 2 is a sectional view of the separator tube 4 taken along an axial plane thereof. As shown in the figure, the ends 20 of the separator tube 4 have been reduced in diameter by swaging in advance. The separator tube 4 has a branch tube 37 formed by burring on a side wall thereof near the left end 20 as viewed in FIG. 2. It should be noted that the burring process and the swaging process are carried out by using conventional burring and swaging devices.

FIG. 3 is a sectional view, taken along an axial plane, of the separator tube 4 set in the beading device 41 and having been subjected to beading to form a housing 22 (O-ring groove) on the left end 20 (as viewed in FIG. 2) thereof. It should be noted that the ends 20 of the separator tube 4 are subjected to beading simultaneously by a pair of beading devices 41. Accordingly, the pair of beading devices 41 are disposed on the same base in symmetry at the left and right sides (as viewed in FIG. 2) of the separator tube 4 having its axis disposed horizontally.

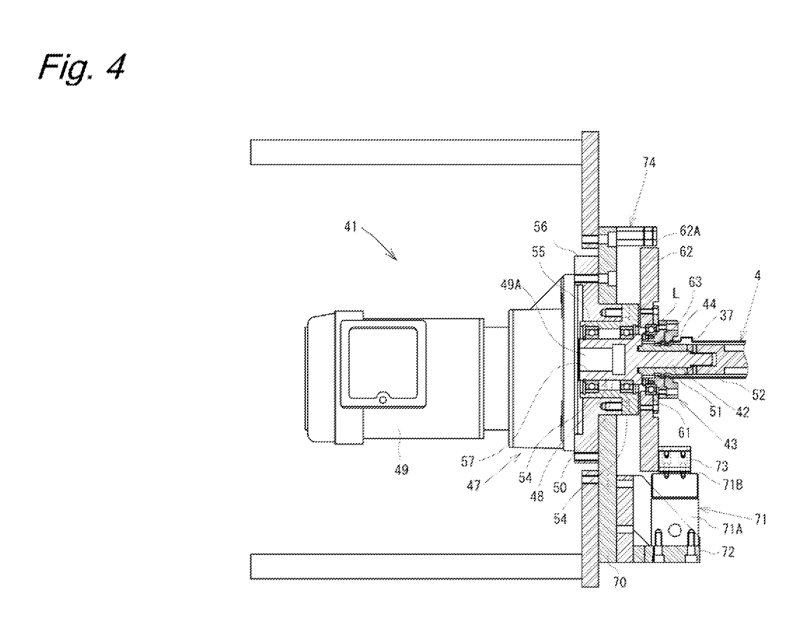

In the following explanation of the beading device 41, which will be made with reference to FIGS. 3 and 4, only the beading device 41 corresponding to the left end 20 as viewed in FIG. 2 will be illustrated, and an illustration of the beading device 41 corresponding to the right end 20 in FIG. 2 will be omitted. In addition, the leftward (left) and rightward (right) directions and the upward (upper) and downward (lower) directions as viewed in FIG. 3 are defined as the “leftward (left) and rightward (right) directions” and the “upward (upper) and downward (lower) directions”, respectively, as they are in FIG. 3.

As shown in FIG. 3, the beading device 41 has a hollow shaft-shaped (shaft-shaped) roller die 42 to be inserted into the inner periphery 21 side of the end 20 of the separator tube 4, and an outer die 43 to be fitted to the outer periphery of the end 20 of the separator tube 4. The roller die 42 has an annular projection 44 formed on an axially (left and right direction) intermediate part thereof to extend circumferentially along the outer periphery of the roller die 42. The projection 44 is formed into a substantially rectangular shape in a section taken along an axial plane of the roller die 42 in correspondence to the housing 22. The roller die 42 has a flange portion 45 formed at a predetermined space from the left side wall of the projection 44 and a flange portion 46 formed at a predetermined space from the right side wall of the projection 44.

The roller die 42 is driven to rotate about the axis by a rotationally driving mechanism 47. The rotationally driving mechanism 47 has a die support 48 supporting the roller die 42 and a servomotor 49 (see FIG. 4) serving as a drive source. The die support 48 has a base portion 50 formed in a substantially circular columnar shape, a first shaft portion 51 to the outer periphery of which the inner periphery of the roller die 42 is fitted, and a second shaft portion 53 connected to a restraining member 52 (described later). The die support 48 is supported at the outer periphery of the base portion 50 by a pair of hearings 54 spaced from each other in the axial direction (left and right direction), thereby being rotatable about the axis. It should be noted that the pair of bearings 54 are accommodated in a substantially circular cylindrical bearing casing 55, which is bolted at a flange portion 55A thereof to a boss portion 56A of a motor base 56.

The die support 48 has a hole 57 opening on the left end surface of the base portion 50 and is power-transmittably connected to a rotating shaft 49A (see FIG. 4) of the servomotor 49 inserted into the hole 57. Further, the die support 48 has a flange portion 58 formed on the right end of the base portion 50. The right bearing 54 is abutted against the left end surface of the flange portion 58. In addition, the flange portion 45 of the roller die 42 is abutted against an inner peripheral portion of the right end surface of the flange portion 58, thereby restraining the leftward movement of the roller die 42 relative to the die support 48. The rightward movement of the roller die 42 relative to the die support 48 is restrained by the restraining member 52 abutted against the right end surface of the roller die 42. Thus, the roller die 42 is axially positioned relative to the outer die 43. It should be noted that the left end portion of the roller die 42 is fitted into an annular recess 59 formed in the right end surface of the base portion 50. The die support 48 is fitted at the distal end of the first shaft portion 51 into a hole 60 formed in the end surface of the restraining member 52.

As shown in FIG. 3, the outer die 43 is formed into an annular shape, and the roller die 42 is inserted into the inner periphery side of the outer die 43. The outer die 43 is attached to an outer-die support plate 62 through a bearing 61. Thus, the outer die 43 is rotatable about the axis (center line) thereof. Further, the outer die 43 has a recess 63 corresponding to the projection 44 of the roller die 42. It should be noted that the sectional configuration of the recess 63 taken along an axial plane of the outer die 43 is a substantially rectangular shape having dimensions set so that the plate thickness of the end 20 after the forming process is substantially uniform throughout the end 20.

The outer die 43 has a relief portion 65 formed on the inner side thereof tit a position rightward of the recess 63 to avoid interference with a tapered portion 64 of the separator tube 4. Further, the outer die 43 has an abutting portion 66 formed on the inner side thereof at a position leftward of the recess 63. The abutting portion 66 has an inner diameter smaller than the inner diameter of a reference inner peripheral surface 43A of the outer die 43. The right end surface of the abutting portion 66 is abutted by an end surface 20B (see FIG. 2) of the end 20 of the separator tube 4, thereby restraining the plastic flow of the material constituting the separator tube 4 during the beading process.

As will be appreciated from FIG. 3, immediately after the completion of beading, the separator tube 4 cannot be removed from the outer die 43 because a raised portion 67 formed at the end 20 of the separator tube 4 has fitted into the recess 63 of the outer die 43. Therefore, the outer die 43 is configured to be splittable into two parts in the axial direction (left and right direction) and splittable into two parts in the radial direction (direction perpendicular to the axis). That is, the outer die 43 comprises a total of four splittable die parts. Thus, the separator tube 4 can be removed by splitting the outer die 43.

In FIG. 3 is shown only a parting line L at which the outer die 43 is splittable in the axial direction. The parting line L extends in the radial direction from a position on the bottom of the recess 63 closer to the right side wall of the recess 63 and further extends radially across a step. In other words, when the two axially splittable die parts of the outer die 43 are joined together, a projection 76 formed on the left end surface of the right die part is fitted into a recess 75 formed in the right end surface of the left die part. Reference numeral 68 shown in FIG. 3 denotes a bearing holder secured to the outer die 43 with bolts. The bearing holder 68 secures the inner ring of the bearing 61 to the outer die 43. Reference numeral 69 shown in FIG. 3 denotes a bearing holder secured to the outer-die support plate 62 with bolts. The bearing holder 69 secures the outer ring of the bearing 61 to the outer-die support plate 62.

As shown in FIG. 4, the outer-die support plate 62 is attached to a base plate 70 through a pair of linear guides. Thus, the outer-die support plate 62 is movable in the up and down direction relative to the base plate 70. As will be appreciated from FIG. 4, the bearing casing 55 is secured to the base plate 70 through the motor base 56. Thus, the outer die 43 is movable in the up and down direction (direction perpendicular to the axis) relative to the roller die 42.

The beading device 41 has a hydraulic cylinder 71 serving as a drive source for driving the outer-die support plate 62. The hydraulic cylinder 71 has a cylinder body 71A secured to a lower part of the base plate 70 through a cylinder base 72 and further has a piston rod 71B secured to a lower part of the outer-die support plate 62 through a connecting member 73. It should be noted that the upward movement of the outer-die support plate 62 is restrained by an external stopper 74 secured to an upper part of the base plate 70.

The beading device 41 has a control unit comprising a microcomputer. The control unit can control the rotation of the servomotor 49, i.e. the rotation of the roller die 42 about the axis. Further, the control unit can control the relative movement between the roller die 42 and the outer die 43 in the up and down direction (direction perpendicular to the axis of the separator tube 4) by controlling the supply and discharge of hydraulic oil pressure to and from the hydraulic cylinder 71. In addition, the control unit can feedback-control the hydraulic cylinder 71 on the basis of working force (pressurizing force) during the beading process. It should be noted that the working force during the beading process can be obtained, for example, from the pressure in the hydraulic circuit of the hydraulic cylinder 71.

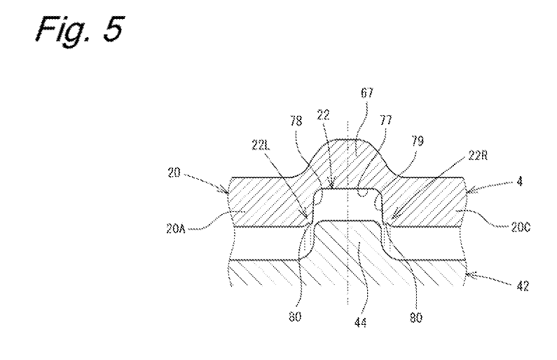

The housing 22 (O-ring groove) obtained by the above-described beading process has an annular shape centered at the axis, which has, as shown in FIG. 5, a bottom surface 77, a first side surface 78 located closer to the opening of the separator tube 4, and a second side surface 79 closer to the back of the separator tube 4. The housing 22 has burrs 80 (acute protrusions) generated on the opening edges at both sides thereof in the axial direction of the separator tube 4, i.e. the edge (hereinafter referred to as “corner 22L”) between the first side surface 78 of the housing 22 and the inner periphery 21, and the edge (hereinafter referred to as “corner 22R”) between the second side-surface 79 of the housing 22 and the inner periphery 21. The burrs 80 are generated owing to the plastic flow of the material constituting the separator tube 4 during the beading process.

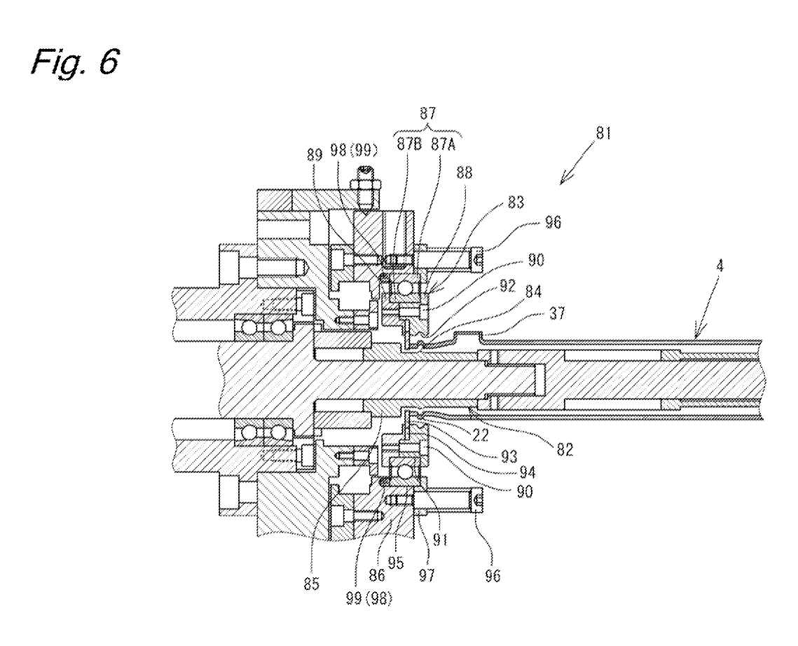

The following is an explanation of a pressing device 81 flattening the burrs 80 of the housing 22 (O-ring groove) obtained by the beading process. FIG. 6 is a sectional view, taken along an axial plane of the separator tube 4, of the pressing device 81 having the separator tube 4 set therein. It should be noted that the housings 22 at the opposite ends 20 of the separator tube 4 are subjected to working simultaneously by a pair of pressing devices 81 in the same way as by the beading devices 41. Accordingly, the pair of pressing devices 81 are disposed on the same base in symmetry at the left and right sides of the separator tube 4 having its axis disposed horizontally.

In the following explanation of the pressing device 81, which will be made with reference to FIG. 6, only the pressing device 81 corresponding to the tell end 20 will be illustrated, and an illustration of the pressing device 81 corresponding to the right end 20 will be omitted, in the same way as the explanation of the beading device 41 made with reference to FIG. 3. In addition, the leftward (left) and rightward (right) directions and the upward (upper) and downward (lower) directions as viewed in FIG. 6 are defined as the “leftward (left) and rightward (right) directions” and the “upward (upper) and downward (lower) directions”, respectively, as they are in FIG. 6.

As shown in FIG. 6, the pressing device 81 has a hollow shaft-shaped (shaft-shaped) roller die 82 to be inserted into the inner periphery 21 side of the end 20 of the separator tube 4, and an outer die 83 to be disposed around the outer periphery of the end 20 of the separator tube 4. The roller die 82 has an annular projection 84 formed on an axially (left and right direction) intermediate part thereof to extend circumferentially along the outer periphery of the roller die 82.

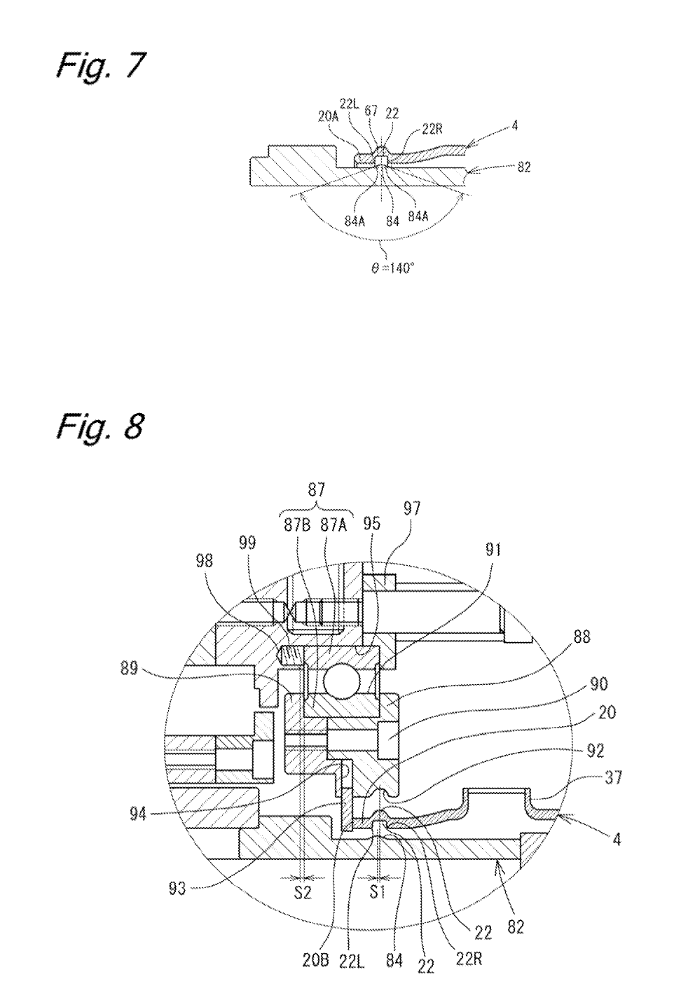

As shown in FIG. 7, the projection 84 is formed into an isosceles triangular shape in a section taken along an axial plane of the roller die 82. The isosceles triangular shape that the section of the projection 84 forms (hereinafter referred to as simply “isosceles triangular shape”) has a vertex angle θ set to 140° so that the equal sides 84A of the projection 84 can flatten the burrs 80 (see FIG. 5) generated on the comers 22L and 22R of the housing 22. It should, however, be noted that the vertex angle θ is not limited to 140°. Further, the projection 84 need not have an isosceles triangular shape in the strict sense of the word but may be formed in the shape of a trapezoid formed by truncating a part of the isosceles triangular shape that includes the vertex angle θ. It should, be noted that reference numeral 85 in FIG. 6 denotes a flange portion of the roller die 82 formed at a predetermined distance leftward from the projection 84.

The roller die 82 is driven to rotate about the axis by a rotationally driving mechanism. It should be noted that the rotationally driving mechanism 47 of the beading device 41 is employed as the rotationally driving mechanism for the pressing device 81. Therefore, an explanation of the rotationally driving mechanism for the pressing device 81 is omitted for the sake of simplifying the description of the specification.

As shown in FIG. 6, the outer die 83 is formed into an annular shape, and the roller die 82 is inserted into the inner periphery side of the outer die 83. The outer die 83 is splittable info two parts in the axial direction (left and tight direction). More specifically, the outer die 83 comprises a first die member 88 and a second die member 89, which are united together with a plurality of bolts 90. The outer die 83 has an annular groove 91 formed on the outer periphery thereof. The groove 91 is fitted with an inner ring 87B of a bearing 87 whose outer ring 87A is supported by an outer-die support plate 86. Thus, the outer die 83 is rotatable about the axis (center line).

The outer die 83 has an annular recess 92 provided on the inner periphery of the first die member 88. The recess 92 is formed to correspond in position and shape to the raised portion 67 of the separator tube 4. The outer die 83 further has a groove 94 formed on the inner periphery thereof at a position leftward of the recess 92, i.e. between the first die member 88 and the second die member 89, to retain an annular abutting plate 93. The separator tube 4 is axially positioned relative to the pressing device 81 by abutting the end 20 of the separator tube 4 against the abutting plate 93.

The outer ring 87A of the bearing 87 is axially slidably fitted to a stepped portion 95 formed on the inner peripheral surface of the outer-die support plate 86, which has a substantially disk-like shape. As shown in FIG. 8, the outer ring 87A is urged axially rightward (in the rightward direction in FIG. 6) by a compression coil spring 99 accommodated in a spring-accommodating part 98 in the bottom of the stepped portion 95, and the axially rightward movement of the outer ring 87A is restrained by a bearing holder 97. It should be noted that there are provided a plurality of sets of spring-accommodating parts 98 and compression coil springs 99 on the same circle centered at the axis (center line) of the outer die 83. The bearing holder 97 is secured to the right side surface of the outer-die support plate 86 by a plurality of stripper bolts 96 lying on the same circle centered at the axis (center line) of the outer die 83.

As shown in FIG. 8, before the working process using the pressing device 81 is started, i.e. in a state where the right end surface of the outer ring 87A of the bearing 87 is abutted against the bearing holder 97, the position of the recess 92 of the outer die 83, i.e. the center of the width of the recess 92 when the axis of the separator tube 4 is taken as an axis of coordinates, coincides with the position of the housing 22 of the separator tube 4, i.e. the center of the width of the housing 22 when the axis of the separator tube 4 is taken as an axis of coordinates. On the other hand, the position of the projection 84 of the roller die 82, i.e. the position of the vertex of the isosceles triangle in section of the projection 84 when the axis of the separator tube 4 is taken as an axis of coordinates, is displaced from the position of the recess 92 of the outer die 83 and the position of the housing 22 of the separator tube 4 toward the opening of the separator tube 4, i.e. leftward in FIG. 8, by a distance S1.

The pressing device 81 is configured as follows. In a state where the raised portion 67 of the separator tube 4 is fitted in the recess 92 of the outer die 83, the projection 84 of the roller die 82 is pressed against the edges between the inner periphery 21 and the housing 22 at the end 20 of the separator tube 4, where the burrs 80 are formed. As a result, a leftward external force acts on and urges the outer die 83 to move leftward. At this time, the outer die 83 can move, together with the bearing 87 as one unit, leftward in FIG. 8 by a distance S2 at the maximum by compressing the compression coil springs 99.

It should be noted that the outer die 83 of the pressing device 81 can be moved in the up and down direction in FIG. 6 relative to the roller die 82 by employing the mechanism including the hydraulic cylinder 71 of the beading device 41, which moves the outer die 43 in the up and down direction (direction perpendicular to the axis) relative to the roller die 82. An explanation of the mechanism for moving the outer die 83 of the pressing device 81 in the up and down direction and the control unit for controlling the movement of the outer die 83 (operation of the hydraulic cylinder) is omitted herein for the sake of simplifying the description of the specification.

In the working process using the pressing device 81, the roller die 82 inserted in the separator tube 4 is rotated about the axis of the roller die 825 and in this state, the outer die 83 is moved upward in FIG. 6 while monitoring the pressure in the hydraulic circuit of the hydraulic cylinder driving the outer die 83. Consequently, the lowermost region (at this point in time) of the recess 92 of the outer die 83 fits to the lowermost region (at this point in time) of the raised portion 67 of the end 20 of the separator tube 4. Then, the separator tube 4 moves upward in such a manner as to be pushed up by the outer die 83.

When the projection 84 of the roller die 82 is pressed against the edges of the housing 22, where the burrs 80 are formed, the rotational force of the roller die 82 is transmitted to the separator tube 4 and the outer die 83. Consequently, the separator tube 4 and the outer die 83 rotate about the respective axes. As a result, the burrs 80 of the housing 22 are flattened over the entire circumference thereof by the projection 84 of the roller die 82. It should be noted that the control of the hydraulic cylinder driving the outer die 83 is working force control in which it is judged whether or not the pressure in the hydraulic circuit has reached a predetermined threshold value.

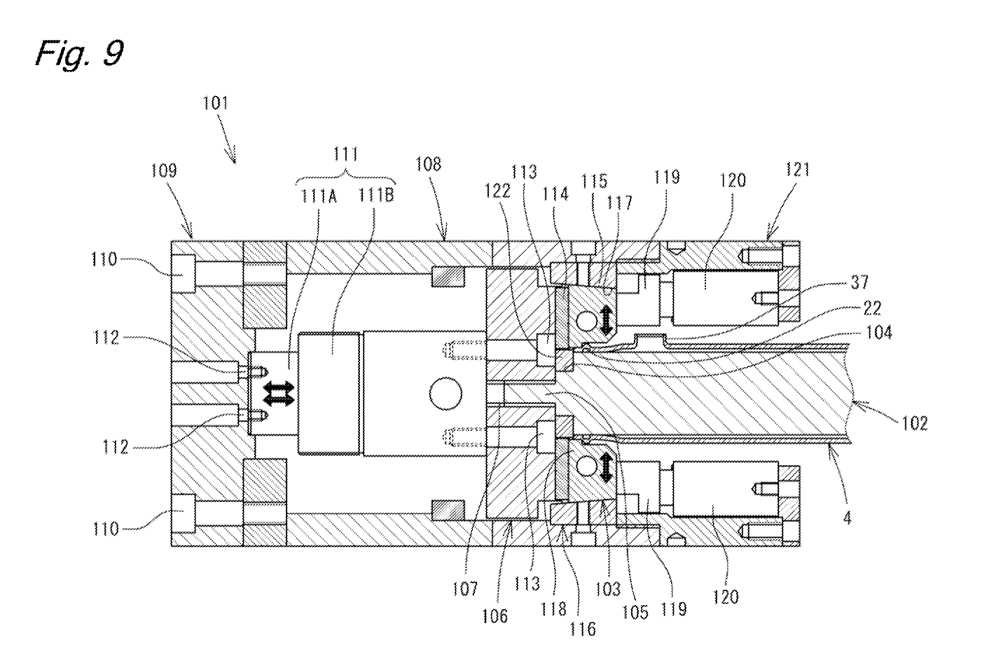

The inner diameter of the end 20 of the separator tube 4 and the inner diameter of the bottom surface 77 of the housing 22 (O-ring groove), obtained by the working process using the above-described pressing device 81, tend to become larger than the required dimensions by about 0.05 mm, for example. Therefore, in this embodiment, the inner diameter of the end 20 of the separator tube 4 obtained by the working process using the pressing device 81 is corrected by using a sizing device 101. FIG. 9 is a sectional view, taken along an axial plane of the separator tube 4, of the sizing device 101 having the separator tube 4 set therein. In the following explanation of the sizing device 101, which will be made with reference to FIG. 9, the leftward (left) and rightward (right) directions and the upward (upper) and downward (lower) directions as viewed in FIG. 9 are defined as the “leftward (left) and rightward (right) directions” and the “upward (upper) and downward (lower) directions”, respectively, as they are in FIG. 9.

The sizing device 101 has a shaft-shaped mandrel 102 to be inserted into the inner periphery 21 side of the end 20 of the separator tube 4, and an outer die 103 to be disposed around the outer periphery of the end 20 of the separator tube 4. The mandrel 102 has a threaded shaft 105 provided at the left end (in FIG. 9) thereof with a boss portion 104 interposed between the threaded shaft 105 and the body portion of the mandrel 102. The threaded shaft 105 is screwed into a threaded hole 107 provided in a substantially disk-shaped pressurizing plate 106 to extend along the axis of the pressurizing plate 106. The pressurizing plate 106 is accommodated in a substantially circular cylindrical sleeve 108. A substantially disk-shaped pressure-receiving plate 109 is secured to the left end of the sleeve 108 with bolts 110, and a rod 111A of a hydraulic cylinder 111 is secured to the pressure-receiving plate 109 with a plurality of bolts 112. Further, a body 111B of the hydraulic cylinder 111 is secured to the left end surface of the pressurizing plate 106 with a plurality of bolts 113.

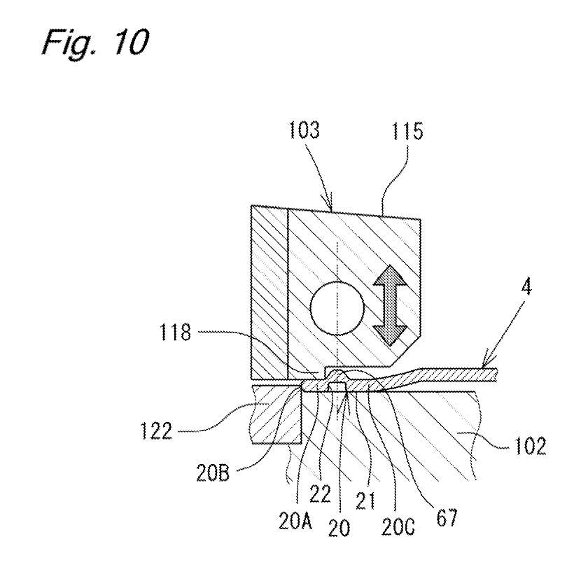

The outer die 103 comprises eight splittable die parts lying on the same circle centered at the axis of the outer die 103 and is held to the right end surface of the pressurizing plate 106. The outer die 103 has an outer tapered surface 115 formed on the outer periphery thereof. The outer tapered surface 115 is tapered rightward as viewed in FIG. 9. The splittable die parts of the outer die 103 are urged outward in the radial direction of the outer die 103 by respective urging mechanisms 114. Thus, the outer tapered surface 115 on the outer periphery of the outer die 103 is brought into slidable contact with an inner tapered surface 117 formed on the inner periphery of a ring member 116 secured to the inner periphery of the sleeve 108. As shown in FIG. 10, the outer die 103 has a pressurizing portion 118 provided on the inner periphery thereof to pressurize a portion 20A of the end 20 of the separator tube 4 that extends axially leftward (leftward in FIG. 10) from the opening of the housing 22, i.e. a portion 20A of the end 20 of the separator tube 4 that is closer to the opening of the separator tube 4 than the housing 22. The portion 20A is pressurized between the pressurizing portion 118 and the mandrel 102.

In the above-described sizing device 101, as the rod 111A of the hydraulic cylinder 111 is extended to move the pressurizing plate 106 rightward relative to the sleeve 108, the outer die 103 is moved axially rightward relative to the sleeve 108 and the ring member 116, with the outer tapered surface 115 sliding on the inner tapered surface 117 of the ring member 116. As will be appreciated from FIG. 9, the outer die 103 operates such that the inner diameter of the pressurizing portion 118 is reduced as the outer die 103 moves rightward relative to the ring member 116. That is, the outer die 103 performs a shrinking operation. Thus, the portion 20A of the end 20 of the separator tube 4, which extends leftward from the housing 22, is pressurized between the mandrel 102 and the outer die 103, and the inner diameter of the portion 20A is corrected.

It should be noted that, as shown in FIG. 9, the right end surface of the outer die 103 is supported by a plurality of gas springs 120 through a ring-shaped support member 119. The gas springs 120 are held by a substantially circular cylindrical spring base 121 secured to the tight end of the sleeve 108. The end surface 20B of the end 20 (portion 20A) of the separator tube 4 is abutted against a ring-shaped restraining member 122 that is fitted to the outer periphery of the boss portion 104 of the mandrel 102 and that is clamped between the left end surface of the mandrel 102 and the right end surface of the pressurizing plate 106, thereby positioning the separator tube 4 axially relative to the outer die 103, and restraining the plastic flow of the material constituting of the separator tube 4 during the sizing process. It should be noted that, although the outer die 103 comprises eight splittable die parts, the configuration of the outer die 103 is not intended to be limited thereto.

The following is an explanation of the method of forming the separator tube 4 (tube) of the damping force control type hydraulic shock absorber 1. It should be noted that, in this embodiment, only the forming process earned out for the left end 20 of the separator tube 4 shown in FIG. 2 will be illustrated, and an illustration of the forming process for the right end 20 of the separator tube 4 will be omitted. The separator tube 4 has, for example, an outer diameter of 40.6 mm and a plate thickness of 1.8 mm. The width of the housing 22 (O-ring groove), i.e. the axial length of the opening of the housing 22, is 2.7 mm.

The separator tube 4 (see FIG. 2) in the form of a stock tube having been subjected to burring and swaging is set in a predetermined support jig. It should be noted that the restraining member 52 can be set inside the separator tube 4 in advance. The stock tube is one that has been formed by drawing and ensured in accuracy of the plate thickness. In this state, the axis of the separator tube 4 is disposed horizontally and coaxially with the axes of the roller die 42 and outer die 43 of the beading device 41. In the following description, when the term “axis” appears alone, it shall refer to the axis of the separator tube 4.

### (Roller Die Inserting and Outer Die Fitting Step)

Next, the beading device 41 is moved in the axial direction. Consequently, the roller die 42 is inserted into the separator tube 4 and engaged with the restraining member 52 in the separator tube 4. Further, the outer die 43 is fitted to the outer periphery of the end 20 of the separator tube 4, and the end surface 20B of the end 20 is abutted against the abutting portion 66 of the outer die 43. As a result, the separator tube 4 is positioned axially and coaxially relative to the roller die 42 and the outer die 43.

### (Groove Forming Step)

Next, the servomotor 49 is driven to rotate the roller die 42 about the axis of the roller die 42. It should be noted that, in this state, there is a preset clearance formed between the roller die 42 (projection 44) and the separator tube 4 (end 20). The number of revolutions of the roller die 42 is set to from 50 to 300 rpm, for example. Next, the outer-die support plate 62 is driven by the hydraulic cylinder 71 to move the outer die 43 upward (in a direction perpendicular to the axis) in FIGS. 3 and 4. When the inner periphery 21 of the end 20 of the separator tube 4 contacts the projection 44 of the roller die 42, frictional force is generated between the end 20 and the projection 44. As a result, the separator tube 4 and the outer die 43 rotate about their axes. At this time, an actual process of forming (beading) a housing 22 is started.

As the outer die 43 moves, the projection 44 cuts into the end 20, and an annular recess serving as a housing 22 is formed on the inner periphery 21 of the end 20. During the beading process, the end 20 is abutted at the end surface 20B against the abutting portion 66 of the outer die 43, and thus the axial plastic flow of the material constituting the end 20 is restrained. In addition, the raised portion 67 on the outer periphery side of the housing 22 is received in the recess 63 of the outer die 43. Therefore, the plate thickness after the forming process is kept uniform. The control unit monitors the working force (forming pressure) during the beading process by detecting the pressure in the hydraulic circuit of the hydraulic cylinder 71. The control unit stops the hydraulic cylinder 71 when the working force reaches a predetermined threshold value. That is, the beading process in this embodiment is performed not by controlling the relative position between the roller die 42 and the outer die 43, but by controlling the working force.

Next, the hydraulic cylinder 71 is driven to move the outer-die support plate 62, and hence the outer die 43, downward (in a direction perpendicular to the axis) as viewed in FIGS. 3 and 4, thereby returning the system to the previous state, i.e. the state where the separator tube 4, the roller die 42 and the outer die 43 are disposed coaxially (see FIG. 3). Next, the rotation of the roller die 42 is stopped, and the outer die 43 is split. In this state, the beading device 41 is retracted, i.e. moved leftward in FIGS. 3 and 4 relative to the separator tube 4, and the separator tube 4 is taken out.

The above-described beading process is a sequential rotary forming process performed by the rotation and revolution of the roller die 42. Therefore, the material constituting the end 20 of the separator tube 4 plastically flows in the circumferential direction to generate burrs 80 (protrusions) as shown in FIG. 5 on the corners 22L and 22R of the housing 22. In this regard, the smaller the width of the housing 22, the greater the height of the burrs 80. If the clearance between the inner tube 3 and die separator tube 4 is close to zero, the burrs 80 cause no problem. However, a predetermined clearance is set between the inner tube 3 and the separator tube 4 in view of assemblability.

Accordingly, if the pressure in the annular hydraulic fluid passage 24 repeatedly changes one-sidedly on the pressure increasing side or the pressure decreasing side in actual use of the product (hydraulic shock absorber 1), for example, each O-ring 23 (see FIG. 1) repeats very small extrusion from the housing 22 and returning thereinto. Accordingly, the extruding portion of the O-ring 23 repeatedly passes over the burrs 80. Consequently, the O-ring 23 may be damaged. Therefore, in this embodiment, there is provided a pressing step of flattening, by the pressing device 81, the burrs 80 on the axially opposite sides of the opening of the housing 22 of the separator tube 4 taken out of the beading device 41.

When the housing 22 (O-ring groove) is formed at the end 20 of the separator tube 4 by beading, the burrs 80 on the left corner 22L of the housing 22 tend to become larger in size than the burrs 80 on the right corner 22R of the housing 22 because the configuration of the end 20 of the separator tube 4 is asymmetric at the left and right sides of the housing 22. In the separator tube 4 of this embodiment, in particular, the burrs 80 are generated one-sidedly on the left corner 22L of the housing 22, i.e. on the corner 22L closer to the opening of the separator tube 4, and no burrs 80 that would damage the O-rings 23 occur on the right corner 22R of the housing 22.

Therefore, in the pressing device 81, as shown in FIG. 8, the position of the projection 84 of the roller die 82 (i.e. the position of the vertex of the isosceles triangle) is displaced from the position of the housing 22 toward the opening of the separator tube 4 (i.e. leftward in FIG. 8) by a distance S1, thereby allowing the projection 84 of the roller die 82 to be pressed one-sidedly against the left corner 22L of the housing 22. It should be noted that, in this embodiment, S1 is empirically set to satisfy the relation of 1.0 mm>S2>S1>0.2 mm. In the relation, S2 is a maximum travel distance in the axial direction of the outer die 83 and the bearing 87 relative to the outer-die support plate 86.

### (Pressing Step)

First, the roller die 82 of the pressing device 81 is inserted into the separator tube 4, and the outer die 83 is disposed around the outer periphery of the end 20 of the separator tube 4. As shown in FIG. 6, the separator tube 4 is axially positioned relative to the roller die 82 and the outer die 83 by abutting the end 20 against the abutting plate 93. In this state, a servomotor (corresponding to the servomotor 49 of the beading device 41) is driven to rotate the roller die 82 about the axis thereof.

Next, the outer-die support plate 86 is driven by a hydraulic cylinder (corresponding to the hydraulic cylinder 71 of the beading device 41) to move the outer die 83 upward (in a direction perpendicular to the axis) in FIG. 6. Consequently, the recess 92 of the outer die 83 is fitted with the raised portion 67 on the outer periphery of the end 20 of the separator tube 4. Thereafter, the separator tube 4 moves upward, together with the outer die 83, with the axis kept horizontal. When the projection. 84 of the rotating roller die 82 contacts the corners 22L and 22R of the housing 22, frictional force is generated between the comers 22L and 22R of the housing 22, on the one hand, and, on the other, the projection 84 of the roller die 82. As a result, the separator tube 4 and the outer die 83 rotate about their axes. At this time, an actual process of forming the housing 22 (flattening the burrs 80) is started.

As shown in FIG. 8, because the position of the projection 84 of the roller die 82 is displaced from the axial center position of the housing 22 toward the opening of the separator tube 4 (leftward in FIG. 8) by a distance S1, first, a portion of the projection 84 that is to the left of the vertex of the projection 84 contacts the left corner 22L of the housing 22. At this point of time, a portion of the projection 84 that is to the right of the vertex of the projection 84 has not yet contacted the right corner 22R of the housing 22. However, as the outer die 83 moves upward, the outer die 83 and the bearing 87 move leftward in FIG. 6 while compressing the compression coil spring 99, and eventually, the axial center position of the recess 92 of the outer die 83 coincides with the vertex (axially center position) of the projection 84 of the roller die 82.

The control unit monitors the working force during the process of flattening the burrs 80 by detecting the pressure in the hydraulic circuit of the hydraulic cylinder. The control unit stops the hydraulic cylinder when the working force reaches a predetermined threshold value. It should be noted that the threshold value of working force acting on the end 20 of the separator tube 4 in the pressing step is set smaller than the threshold value of working force acting on the end 20 of the separator tube 4 in the groove forming step. Thus, it is possible to flatten the burrs 80 on the axially opposite corners 22L and 22R of the opening of the housing 22 over the entire circumference.

As has been stated above, the separator tube 4 taken out of the pressing device 81 alter the completion of the pressing step tends to be such that the inner diameter of the portion 20A of the end 20, which extends axially leftward (leftward in FIG. 10) from the opening of the housing 22, and the inner diameter of the bottom surface 77 of the housing 22 (O-ring groove) become larger than the required dimensions by about 0.05 mm, for example. Therefore, in this embodiment, a sizing step is provided to correct the inner diameter of the end 20 of the separator tube 4 obtained by the pressing step.

### (Sizing Step)

First, the separator tube 4 is fitted to the outer periphery of the mandrel 102 of the sizing device 101. Consequently, the separator tube 4 is positioned coaxially with the sleeve 108 and the outer die 103. In addition, the end surface 20B of the end 20 is abutted against the restraining member 122, thereby allowing the separator tube 4 to be axially positioned relative to the sleeve 108. It should be noted that, when the sizing device 101 is in its initial state, the pressurizing plate 106 is placed at a retraction terminating position (i.e. leftward movement terminating position in FIG. 9) by the contracted rod 111A of the hydraulic cylinder 111. In this initial state, the outer die 103 is located more leftward than its position shown in FIG. 9 relative to the ring member 116. Thus, the inner diameter of the pressurizing portion 118 of the outer die 103 is at a maximum, which is larger than the outer diameter of the separator tube 4.

In this state, the rod 111A of the hydraulic cylinder 111 is extended to move the pressurizing plate 106 rightward in FIG. 9. Consequently, the outer die 103 moves rightward relative to the ring member 116 while compressing the gas springs 120 and causing the outer tapered surface 115 to slide on the inner tapered surface 117 of the ring member 116. At the same time, the separator tube 4 moves rightward, together with the pressurizing plate 106 and the mandrel 102. That is, even when the pressurizing plate 106 is moved in the axial direction (left and right direction in FIG. 9), the separator tube 4 and the outer die 103 do not move relative to each other in the axial direction.

When, as shown in FIG. 10, the pressurizing portion 118 of the outer die 103 abuts against the portion 20A at the end 20 of the separator tube 4, which extends axially leftward (leftward in FIG. 10) from the opening of the housing 22, an actual process of sizing the housing 22 is started, and the portion 20A is corrected in size by being pressurized between the mandrel 102 and the pressurizing portion 118 of the outer die 103. It should be noted that the restraining member 122 stops the plastic flow of the material constituting the end 20 of the separator tube 4 in the leftward direction in FIG. 10.

The control unit monitors the working force (forming pressure) during the sizing process by detecting the pressure in the hydraulic circuit of the hydraulic cylinder 111. The control unit stops the hydraulic cylinder 111 when the working force reaches a predetermined threshold value. Next, the rod 111A of the hydraulic cylinder 111 is contracted to return the sizing device 101 to the initial state. Thus, the inner diameter of the pressurizing portion 118 of the outer die 103 is enlarged, thereby allowing the separator tube 4 to be removed from the mandrel 102.

The opening of the housing 22 of the separator tube 4 removed from the mandrel 102 has an impression pressed on at least the left corner 22L. The inner diameter of the portion 20A at the end 20 of the separator tube 4, which extends from the opening of the housing 22 to the opening of the separator tube 4, is smaller than the inner diameter of a portion 20C (see FIG. 10) of the separator tube 4 extending in the opposite direction (rightward in FIG. 9) to the portion 20A. In this embodiment, the inner diameter of the portion 20A extending from the opening of the housing 22 to the opening of the separator tube 4 is larger than the outer diameter of the mandrel 102 by 0.05 mm.

### (Advantages)

According to the conventional related art, it is unavoidably necessary to use cutting to form a housing 22 (O-ring groove) on the inner periphery 21 side of the separator tube 4 so that the accuracy of form of the housing 22 will conform to the standard sizes for the housing 22 specified by JIS B2401. This causes an increase in the manufacturing cost. If the housing 22 is formed by press working using a punch and a die, for example, a seam is formed on the housing 22 undesirably, and the roundness required for the end 20 cannot be ensured.

On the other hand, when the housing 22 is formed by beading, burrs 80 undesirably occur on at least one of the corners 22L and 22R of the opening of the housing 22, regardless of the shape of the projection 44 of the roller die 42. The problem, of the burrs 80 could not been solved. The burrs 80 are more likely to occur as the width of the opening of the housing 22 reduces. The burrs 80 may damage the O-ring 23.

Accordingly, the forming method of this embodiment includes the following three steps: (1) a groove forming step of forming the housing 22 (O-ring groove) on the inner periphery 21 of the end 20 of the separator tube 4 by beading using the roller die 42 and the outer die 43; (2) a pressing step of pressing at least one of the corners 22L and 22R of the opening of the housing 22 with the projection 84 of the roller die 82, which has an isosceles triangular shape in section, thereby forming an impression on the at least one of the corners 22L and 22R; and (3) a sizing step of sizing at least one of the portions 20A and 20C of the end 20 of the separator tube 4, which extend axially from the opening of the housing 22, by the mandrel 102 and the pressurizing portion 118 of the outer die 103, thereby correcting the inner diameter of the at least one of the portions 20A and 20C.

According to the forming method of this embodiment, because it includes the above-described three steps (1) to (3), a housing 22 conforming to the standard sizes specified by JIS B2401 can be formed on the inner periphery 21 of the end 20 of the separator tube 4 without performing cutting. Consequently, a separator tube 4 having high sealing performance (20 MPa in this embodiment) can be manufactured at reduced cost, and hence, it is possible to reduce the manufacturing cost of the damping force control type hydraulic shock absorber 1. Further, because a housing 22 having high dimensional accuracy can be formed, it is possible to employ an O-ring 23 using no backup ring and hence possible to further reduce the manufacturing cost. It should be noted that the groove width (2.7 mm in this embodiment) of the opening of the housing 22 corresponding to the O-ring 23 using no backup ring is smaller than the groove width (e.g. 4.0 mm) of the opening of a housing corresponding to an O-ring using a backup ring, and that the smaller the groove width, the greater the height of the burrs 80 (acute protrusions) generated in the groove forming step. In this embodiment, however, the burrs 80 can be flattened by the pressing step. In the groove forming step, the housing 22 can be formed with high accuracy on the inner periphery 21 of the end 20 of the separator tube 4 by machining (beading). The housing 22 obtained by the groove forming step has burrs 80 (acute protrusions) generated on at least one of the comers 22L and 22R of the opening thereof. Therefore, in the pressing step, the at least one of the corners 22L and 22R of the opening of the housing 22 formed by the groove forming step is pressed with the projection 84 of the roller die 82, which has an isosceles triangular shape in section, to flatten the burrs 80 on the at least one of the comers 22L and 22R of the opening of the housing 22, thereby forming an impression on the at least one of the comers 22L and 22R of the opening of the housing 22. In this embodiment, the working force in the pressing step is set smaller than the working force in the groove forming step; therefore, the housing 22 can be prevented from being deformed by the pressing step. However, the accuracy of the inner diameter of the end 20 of the separator tube 4 obtained through the pressing step is lower than that before the pressing step. Accordingly, in the sizing step, the end 20 of the separator tube 4 obtained through the groove forming step and the pressing step is subjected to sizing to correct the inner diameter of the end 20 of the separator tube 4. The correction of the inner diameter of the end 20 of the separator tube 4 makes it possible to adjust the inner diameter of the end 20 with high accuracy. Therefore, when the separator tube 4 is assembled around the outer periphery of the inner tube 3 of the hydraulic shock absorber 1, the clearance between the inner tube 3 and the separator tube 4 cars be held constant, and the O-ring 23 can be prevented from becoming dislodged. It should be noted that, although in this embodiment an O-ring is used as an example of a seal ring, the present invention is not limited thereto but applicable to any type of seal ring, e.g. a square ring having a rectangular sectional configuration, and a lip ring having a V-shaped sectional configuration.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The present application claims priority under 35 U.S.C. section 119 to Japanese Patent Application No. 2012-217073, filed on Sep. 28, 2012. The entire disclosure of Japanese Patent Applications No. 2012-217073, filed on Sep. 28, 2012 including specification, claims, drawings and summary is incorporated herein by reference in its entirety.

What is claimed is:

1. A tube forming method of forming a groove for a seal ring on an inner periphery side of a tube, the method comprising:
a roller die inserting and outer die fitting step of inserting a shaft-shaped roller die into the inner periphery side of the tube, the roller die having a projection corresponding to the groove on an outer periphery thereof and of fitting an outer die to an outer periphery of the tube, the outer die comprising at least two splittable die parts and having a recess corresponding to the projection on an inner periphery thereof;
a groove forming step of rotationally driving the roller die to form the groove on an inner peripheral surface of the tube;
a pressing step of pressing at least one corner of an opening of the groove: and
a sizing step of sizing at least one of portions of the tube extending from the opening of the groove in an axial direction of the tube into a predetermined inner diameter dimension.

2. The tube forming method of claim 1, wherein force applied to the tube in the pressing step is smaller than force applied to the tube in the groove forming step.

3. The tube forming method of claim 1, wherein the pressing step presses both corners of the opening of the groove simultaneously.

4. A shock absorber installed between two members movable relative to each other, the shock absorber comprising:
a cylinder having a hydraulic fluid sealed therein;
a piston inserted in the cylinder;
a piston rod connected to the piston and extending to an outside of the cylinder;
an outer tube provided around an outer periphery of the cylinder;
a separator tube provided around the outer periphery of the cylinder, the separator tube having a circular cylindrical side wall forming an annular passage communicating with an interior of the cylinder;
a reservoir formed outside the separator tube between the cylinder and the outer tube, the reservoir having the hydraulic fluid and a gas sealed therein; and
a damping force generating mechanism disposed outside the outer tube;
the separator tube having a circumferentially extending seal ring groove formed on an inner periphery side thereof;
the seal ring groove having an opening with an impression pressed on at least one side thereof in an axial direction of the separator tube;
wherein an inner diameter of a portion of the separator tube that extends from the opening of the seal ring groove toward one side of the axial direction is smaller than an inner diameter of a portion of the separator tube that extends from the opening of the seal ring groove toward an other side of the axial direction.
